(19) United States
(12) Patent Application Publication
(10) Pub. No.: US 2025/0034913 A1
(43) Pub. Date: Jan. 30, 2025

(54) INERTIAL SAFETY SYSTEM FOR A VEHICLE DOOR HANDLE

(71) Applicant: MINEBEA ACCESSSOLUTIONS ITALIA S.P.A., Pianezza (IT)

(72) Inventor: Simone ILARDO, Pianezza (IT)

(73) Assignee: MINEBEA ACCESSSOLUTIONS ITALIA S.P.A., Pianezza (IT)

(21) Appl. No.: 18/716,168

(22) PCT Filed: Dec. 13, 2022
(86) PCT No.: PCT/EP2022/085667

§ 371 Date: Jun. 4, 2024

(30) Foreign Application Priority Data
Dec. 15, 2021 (EP) 21214906.6

(51) Int. Cl. E05B 77/06

(52) U.S. Cl. CPC E05B 77/06

(57) ABSTRACT

An inertial system for a vehicle door handle assembly includes a locking device to prevent the actuation of the door handle upon activation and a first inertial mass. When subjected to an acceleration force acting in a first acceleration direction, the first inertial mass moves along a first movement direction from a rest position allowing the opening of the door by actuation of the door handle, to a locking position activating the locking device. The inertial system also includes a second inertial mass, which, when subjected to an acceleration force acting in a first acceleration direction opposite the first acceleration direction, moves along a second movement direction, from a rest position allowing the opening of the door by actuation of the door handle to a locking position activating the locking device. The first movement direction is opposite the second movement direction.

The invention relates to a safety device for a vehicle door handle, in particular to avoid unsolicited opening of said door during a side crash scenario.

When a vehicle undergoes a lateral collision, the inertia of the handle pieces can lead to an actuation of the door latch. A major risk in that case is the opening of the door, which may lead to the occupants being injured by being exposed to the outside environment or even thrown out of the vehicle.

To avoid that risk, almost all current vehicle handles integrate components dedicated to block the kinematics of the handle, and thus prevent door opening upon impact. These blocking or locking components are triggered by being subjected to an acceleration above a predetermined threshold (usually several tens of g) and are thus usually called “inertial systems” or “inertial lockers”.

Current inertial systems are usually divided into two categories: reversible and irreversible.

Reversible inertial systems generally include a mass that is linked to the locking component in such a way that it triggers the locking of the door when it moves when subjected to an acceleration above a predetermined threshold. Said mass is configured to come back to its rest position once the acceleration has decreased. Such a system is for example known from document WO2004042177.

The main advantage of a reversible inertial system is that after a crash, the handle (unless it has been destroyed during the crash) is again free to operate such that pulling on the handle will allow to open the door. This can be helpful to rescue the passengers. Another advantage of such a system is its high reactivity: being reversible, its sensitivity to variations in acceleration can be set as high as there is no risk to block the handle use permanently during a normal use.

On the other hand, this sensitivity turns into a disadvantage as rebounds, i.e. alternate accelerations forces, may occur during the crash and trigger, though rarely, a brief unlocking of the door handle as the mass may return briefly to its original rest position. Moreover, the behaviour of a reversible inertial system is difficult to anticipate in real conditions. To avoid this, damping systems can be introduced in the inertial system kinematics to dampen the return to the rest position. Such a system is for example known from document WO 2008/068262.

Irreversible systems, in turn, include components which simply permanently block the handle lever rotation and prevent door opening when subject to an acceleration above a predetermined threshold. Such a system is for example known from document WO2006003197.

The main advantage of an irreversible inertial system is that once triggered, no rebounds can occur as it is definitively locked. On the other hand, its sensitivity has to remain low as it must not be triggered during situations that may involve high accelerations but remain in the domain of a normal use of the vehicle (door slamming, vibrations, etc.), which may cause a delay in activation during a crash. Another disadvantage lies in the fact that the door cannot be opened after the crash due to definitive locking. This may be considered acceptable from a regulations point of view, but not for some original equipment manufacturers (OEM).

It has thus been sought to provide a reversible inertial system that is less affected by rebounds, i.e. has less chances of briefly unlock the door handle when subjected by alternate acceleration forces.

To that end, inertial systems comprising two masses driven by inertia under opposite acceleration forces have been considered. Such a system is known EP 2 818 614. However, the spatial configuration and kinematics of the inertial system shown in this document, in particular owing to the shape of its components and their movement scheme, make it voluminous.

The purpose of the invention is therefore to provide an inertial system that has high reactivity, prevents rebounds and the behaviour of which is predictable, all the while allowing door opening even after a crash, that is compact.

To that end, the invention is directed to an inertial system for a vehicle door handle assembly comprising:
a locking device configured to prevent the actuation of the door handle assembly upon activation,
   a first inertial mass, which, when subjected to an acceleration force acting in a first acceleration direction, is configured to move along a first movement direction from a rest position allowing the opening of the door by actuation of the door handle, to a locking position activating the locking device,
   characterized in that it also comprises a second inertial mass, which, when subjected to an acceleration force acting in a second acceleration direction opposite the first acceleration direction, is configured to move along a second movement direction, from a rest position allowing the opening of the door by actuation of the door handle to a locking position activating the locking device, the first movement direction being opposite the second movement direction.

Thanks to the presence of not one, but two inertial masses, and the fact that they move from a rest position to the blocking position according to two opposite directions, the inertial system may act like a reversible inertial system with high sensitivity, all the while having a predictable behaviour in case of rebounds. In the case of a crash, the initial acceleration due to the impact will trigger the movement of one or both masses, thus blocking the actuation of the door handle assembly. Then, in the case of a rebound, even if a subsequent acceleration occurs along an opposite direction, it will not cause the unlocking of the door as it will trigger the movement of the second mass, thus maintaining the blocking of the actuation of the door handle assembly.

In addition, owing to the fact that the masses move from their rest position to their locking position along two different directions allows for a more compact configuration of the masses, as they can be located on the same side of a pivoting axis for example.

In order to further ensure the compacity of the inertial system, the locking device for example comprises a locking end and at least a driven end, the locking device being movable between a locking position in which the locking end comes into contact with the door handle, for example via a blocking device, to prevent actuation of the door handle and a rest position into which the locking end is not in contact with the door handle, for example via a blocking device, the movement between the rest and locking position and vice versa being driven by a force applied by a driving end that is linked to the first and/or second inertial mass onto the driven end.

For simplicity purposes, the movement according to which the locking device moves between the rest and the locking position is for example a pivoting movement.

For simplicity purposes, the inertial system for example comprises a primary rotation axis and a first pivoting part pivoting about said primary rotation axis, the first inertial mass being supported by said first pivoting part.

In order to further ensure the compacity of the inertial system, the locking device is for example supported by the primary rotation axis and its rotational movement is a pivoting movement about the primary rotation axis.

According to a preferred embodiment, the first pivoting part for example comprises a first body linking a fixed end mounted on the primary rotation axis to a first mass end supporting the first inertial mass.

In order to further ensure the compacity of the inertial system, the driven end is for example in contact and driven by the first body.

According to a preferred embodiment the inertial system preferably comprises a secondary rotation axis and a second pivoting part pivoting about said secondary rotation axis, the second inertial mass being supported by said second pivoting part.

In order to further ensure the compacity of the inertial system, the second pivoting part for example comprises a driving end and a second mass end, the driving end and the second mass end being located from either side of the secondary rotation axis.

According to a preferred embodiment of the invention, the locking device comprises a first driven end and a second driven end, the movement between the rest and locking position and vice versa being driven by a force applied by a first driving end that is linked to the first inertial mass onto the first driven end or a force applied by a second driving end that is linked to the second inertial mass onto the second driven end.

Preferably, the driven end is for example in contact and driven by the driving end.

So as to facilitate the reversibility of the inertial system by helping the locking device to revert to its rest position, the inertial system also comprises first elastic means, said first elastic means being in a minimal tensile stress state when the locking device is in rest position, and configured to apply a force or torque on the locking device, to bring said locking device from the locking position back in rest position.

So as to facilitate the reversibility of the inertial system by helping the first inertial mass to revert to its rest position, the inertial system also comprises second elastic means, said second elastic means being in a minimal tensile stress state when the first inertial mass is in rest position, and configured to apply a force or torque on the first inertial mass, to bring said first inertial mass from the locking position back in rest position.

The second elastic means can be removed to simplify the embodiment and the first inertial mass can be reverted to rest position by the action of the locking device.

So as to facilitate the reversibility of the inertial system by helping the first inertial mass to revert to its rest position, the inertial system for example also comprises third elastic means, said third elastic means being in a minimal tensile stress state when the first inertial mass is in rest position, and configured to apply a force or torque on the first inertial mass, to bring said first inertial mass from the locking position back in rest position.

In order to prevent the locking device from going back to its rest position too rapidly, i.e. to ensure that the door stays locked during the whole duration of the crash, the inertial system for example also comprising dampening means, said dampening means delaying the bringing back of the locking device from the locking position back to the rest position by a predetermined period of time, preferably above least 0.5 s, for example between 0.5 s and 1 s. The predetermined period of time is chosen to correspond to a nominal crash duration, which usually lasts less than a second.

So as to reduce the impact forces to which the masses are subjected when moving from a rest position to a locking position and vice versa, and also to reduce the noise made, at least one of the first and second inertial masses for example comprises a socket in which a bumper can be inserted, said bumper being preferably made out of rubber and injected in the socket.

### BRIEF DESCRIPTION OF THE FIGURES

The invention will be better understood in view of the following description, referring to the annexed Figures in which:

FIG. 1 is schematic perspective view of a door handle assembly comprises an inertial system according to a particular embodiment of the invention;

FIG. 2 is a side view of the inertial system of FIG. 1, the first inertial mass and the second inertial mass being in their respective rest positions;

FIG. 3 is view similar to FIG. 2, in which the locking body has been removed;

FIG. 4 is a top view of the inertial system of FIG. 1, the first inertial mass and the second inertial mass are in their respective rest positions and in which the housing, the primary rotation axis and the dampening means have been removed;

FIG. 5 is a view similar to FIG. 2, the first inertial mass being in its blocking position and the second inertial mass being in its rest position;

FIG. 6 is view similar to FIG. 4, the first inertial mass being in its blocking position and the second inertial mass being in its rest position;

FIG. 7 is a view similar to FIG. 2, the first inertial mass being in its rest position and the second inertial mass being in its blocking position;

FIG. 8 is view similar to FIG. 4, the first inertial mass being in its rest position and the second inertial mass being in its blocking position.

### DETAILED DESCRIPTION

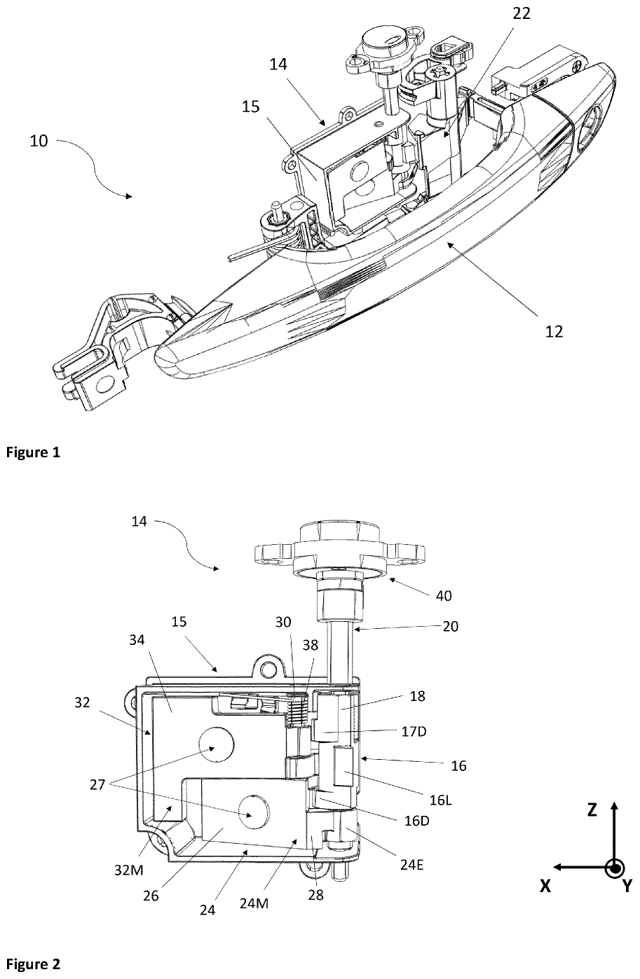

A vehicle door handle assembly 10 according a particular embodiment of the invention has been shown on FIG. 1.

The vehicle door handle assembly 10 comprises a door handle 12, which here is known from the prior art, and usually comprises a bracket (not shown for the sake of comprehension) onto which is affixed an inertial system 14.

Inertial system 14 comprises a locking device 16 configured to prevent the actuation of the door handle 12 upon activation. Inertial system 14 is protected by a housing 15 which here is substantially parallelepipedal in shape, but this may vary.

Locking device comprises a locking body 18 that is mounted pivotably on a primary rotation axis 20. Considering the orientation of the Figures and the frame shown on those Figures, primary rotation axis 20 extends along axis Z.

In the example shown on the Figures, and is more particularly shown on FIG. 2, locking body 18 is substantially cylindrical in shape and is hollowed out (i.e. locking body 18 is annular) to accommodate primary rotation axis 20. Hence, locking body 18 extends along primary rotation axis 20. In that way, locking device 16 may pivot about primary rotation axis 20.

Moreover, locking device 16 comprises a locking end 16L, a first driven end 16D and a second driven end 17D.

Here, the locking end 16L and both driven ends 16D, 17D project from locking body 18 substantially perpendicularly to primary rotation axis 20.

To be more specific, driven ends 16D, 17D project from locking body 18 on the same side of the primary rotation axis 20, while locking end 16L is placed on the opposite side of primary rotation axis 18. Here, to simplify the manufacturing of locking device 16, locking body 18, locking end 16L and driven end 16D are made of one piece.

To optimize the volume occupied by the inertial system 14, locking end 16L is located between driven ends 16D, 17D along primary rotation axis 20.

Locking end 16L extends along an axis that is parallel to primary rotation axis 20. Locking end 16L here has a trapezoidal section, but other sections could be envisioned. At any rate, preferably locking end 16L comprises a planar surface that comes into contact with a blocking device 22 that prevents opening of the handle door 12 as will now be explained.

Both driven end 16D, 17D also extend along an axis that is parallel to primary rotation axis 20 and extends in such a way that is longer than the whole length of locking body 18. Both driven ends 16L here have a trapezoidal section, but other sections could be envisioned. At any rate, preferably both driven ends 16D, 17D also comprises a planar surface for a purpose that will become apparent later on. Here first driven end 16D is slightly longer than second driven end 17D along primary rotation axis 20.

Locking device 16 is movable between a locking position in which the locking end 16L comes into contact with the door handle 12, here with a blocking device 22 to prevent actuation of the door handle 12, and a rest position in which the locking end 16L is not in contact with the door handle 12 via the blocking device 22.

The movement according to which the locking device 16 moves between the rest and the locking position is a pivoting movement. Here, said pivoting movement is about primary rotary axis 20.

Inertial system 14 also comprises a first pivoting part 24 pivoting about primary rotation axis 20. First pivoting part 24 is located facing first driven end 16D.

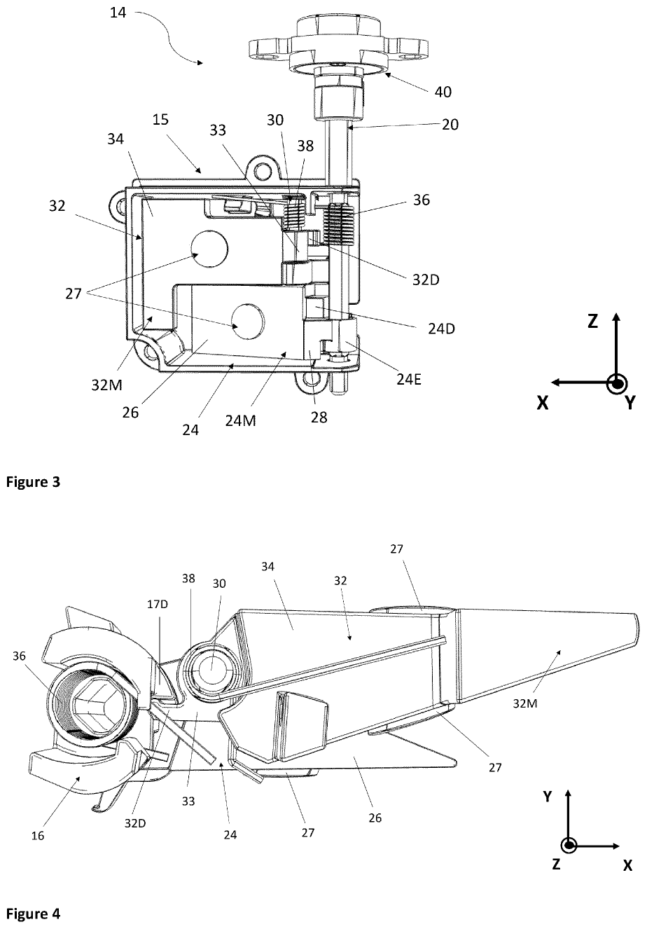

In the embodiment shown on the Figures, and more particularly as shown on FIGS. 2 and 3, first pivoting part 24 comprises a first body 28 linking a fixed end 24E mounted on the primary rotation axis 20 to a first mass end 24M supporting a first inertial mass 26. In other words, first pivoting part 24 is lever-shaped.

In the present example, fixed end 24E is substantially cylindrical and is hollowed-out (i.e. fixed end 24E is annular) to accommodate first pivoting axis 20, much like locking body 18. Hence fixed end 24E extends along primary rotation axis 20. However, compared to locking body 18, fixed end 24E extends along a smaller portion of the length of primary rotation axis 20.

First inertial mass 26 may be provided with a socket in which a bumper 27 can be inserted. For example, bumper 27 may be made of rubber or any comparable material and injected in the socket. Bumper 27 reduces the noise impact of inertial masses 26 when it moves about and hits its position stop. This movement will be explained later on.

First pivoting part 24 also comprises a first driving end 24D, visible on FIG. 3, which here projects from first inertial mass 26 towards driven end 16D so as to face it. Considering the configuration shown on FIGS. 2 and 3, first driving end 24D extends perpendicularly to primary rotation axis 20.

Driven end 16D of the locking device may be contact, here via its planar surface, with first driving end 24, and is also driven by first body 28 as will be explained now.

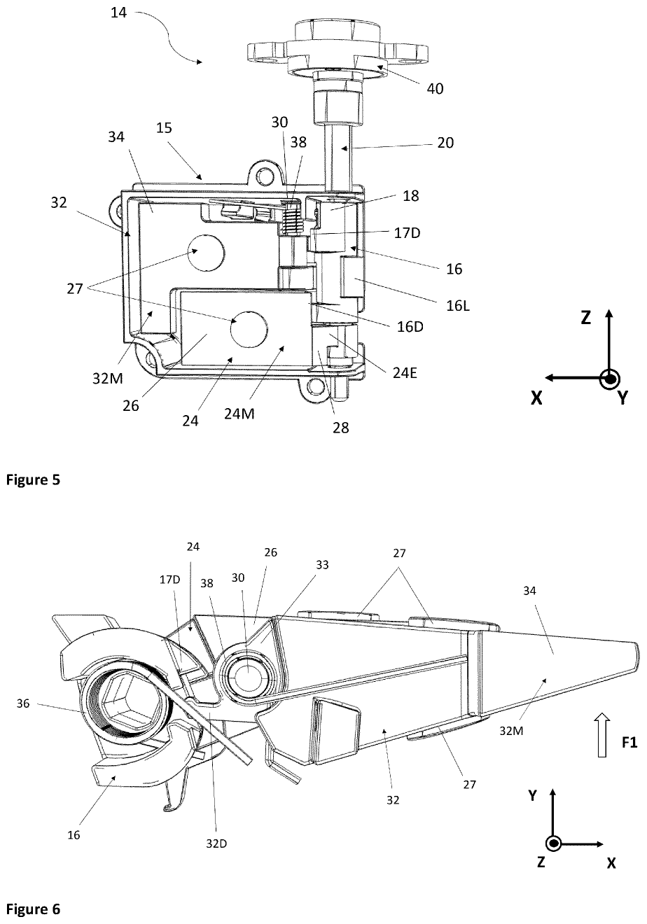

Indeed, first inertial mass 26 is configured such that, when subjected to an inertial force (noted F1 on FIG. 6) acting in a first acceleration direction, is configured to move along a first movement direction from a rest position, shown on FIGS. 2, 3 and 4, allowing the opening of the door by actuation of the door handle 12, to a locking position, shown on FIGS. 5 and 6, activating the locking device 16.

Considering the orientation of the Figures and the frame represented on said Figures, the first acceleration direction is the opposite direction of axis Y.

Here, the initial first movement direction is also the direction of axis Y, the overall movement of first inertial mass 26 being a rotational movement about first pivoting axis 20. Said rotational movement is in a counter clockwise direction in the example shown on the Figures.

Hence, due to the contact between the first driven end 16D of the locking device 16 and first driving end 24D, the movement between the rest and locking position of the locking device 16 and vice versa is driven by a force applied by the first inertial mass 26 onto the first driven end 16D.

Inertial system 14 also comprises a secondary rotation axis 30 and a second pivoting part 32 pivoting about said secondary rotation axis 30. Second pivoting part 32 is located facing first driven end 16D.

Secondary rotation axis 30 here is parallel to first rotation axis 20.

Second pivoting part 32 comprises a second body 33 linking a driving end 32D and a second inertial mass 34. Second body 33 is hollowed-out to accommodate mounted on the secondary rotation axis 30 such. The second driving end 32D and the second mass end are thus located from either side of the secondary rotation axis 30.

Second driven end 17D of the locking device may be in contact with and driven by the driving end 32D of second pivoting part 32.

Second inertial mass 34 may also be provided with a bumper much like first inertial mass 26.

When subjected to an acceleration force (noted F2 on FIG. 8) acting in a second acceleration direction opposite the first acceleration direction, second inertial mass 34 is configured to move along a second movement direction, from a rest position, shown on FIGS. 3 and 4, allowing the opening of the door by actuation of the door handle 12 to a locking position activating the locking device 18.

Considering the orientation of the Figures and the frame represented on said Figures, the second acceleration direction is the direction of axis Y.

The second movement direction, i.e. the direction along which the second inertial mass 26 moves from its rest position to its locking position, is opposite the first movement direction of the first inertial mass 26.

Here, the initial second movement direction is also the direction opposite of axis Y, the overall movement of second inertial mass 34 being a rotational movement about secondary rotation axis 30. Said rotational movement is in a clockwise direction in the example shown on the Figures.

Hence, due to the contact between driven end 16D (or 17D in a variant not shown on the Figures) of the locking device and driving end 32D of the second pivoting part, the movement between the rest and locking position of the locking device 16 and vice versa is driven by a force applied by the second inertial mass 34 onto the driven end 16D (or 17D in a variant not shown on the Figures).

So as to facilitate the reversibility of the inertial system 14 by helping the first inertial mass 26 to revert to its rest position, the inertial system 14 also comprises first elastic means 36 which are in a minimal tensile stress state when the locking device 16 is in rest position, and is configured to apply a force or torque on the locking device 16, to bring said locking device 16 from the locking position back in rest position.

In the present case, as shown on FIG. 2, first elastic means 36 include a spring, visible on FIGS. 3, 4 and 8, coiled about primary rotation axis 20 on its first end, as is known by the skilled person. To be more specific, spring 36 acts more particularly between locking device 16 and housing 15, to which it is connected at its other end.

In the same way, to facilitate the reversibility of the inertial system by helping the second inertial mass 34 revert to its rest position, the inertial system 14 also comprises second elastic means 38 which are in a minimal tensile stress state when the second inertial mass 34 is in rest position, and configured to apply a force or torque on the second inertial mass 34, to bring said inertial mass 34 from the locking position back in rest position.

In the present case, as shown on FIGS. 2 to 8, second elastic means 38 include a spring coiled about secondary rotation axis 30, as is known by the skilled person. To be more specific, spring 38 acts more particularly between second inertial mass 34 and support 15, to which it is connected at its other end as can be seen on FIG. 2.

In the configuration as shown on the Figures, first inertial mass 26 is directly pushed back in rest position by locking device 16, in order to minimize the number of elastic means.

However, in a non-represented embodiment, to further facilitate the reversibility of the inertial system by helping locking device 16 to revert to its rest position, the inertial system for example may also comprise third elastic means which are in a minimal tensile stress state when the first inertial mass 26 is in rest position, and configured to apply a force or torque on the locking device 16, to bring said first inertial mass 26 from the locking position back in rest position.

In order to prevent the locking device 16 from going back to its rest position too rapidly, i.e. to ensure that the door stays locked during the whole duration of the crash, the inertial system 14 also comprises dampening means 40.

Dampening means 40 preferably is unidirectional damper, for example a unidirectional oil damper. Dampening means 40 are free to rotate when the locking device 16 rotates from the rest position towards the locking positions so as to not hinder the movement of the locking device when it rotates from the rest position to the locking position. However, when the locking device 16 rotates from the blocking position towards the rest position, dampening means 40 delays this movement. and is dumped when come back. The dampening effect could be obtained with different systems such as ones using magnets or friction.

Preferably, dampening means 40 delay the bringing back of the locking device from the locking position back to the rest position by a predetermined period of time, preferably above least 0.5 s, for example between 0.5 s and 1 s. The predetermined period of time is chosen to correspond to a nominal crash duration, which usually lasts less than a second. The delay is given by the relation between the dampening torque of the damper and the torque of the first elastic means, here spring 36.

The way the inertial system 14 operates will now briefly explained.

Under high accelerations (crash conditions) the masses 26, 34 pivot about their respective axes 20, 30 to their inertia and, by contact with either the driven end 16D or 17D of the locking device 16, make the locking device 16 pivot until it reaches the blocking device 22 which prevents the door handle 12 from being actuated and thus the vehicle door from being opened.

To be more precise, under a force F1 along a first acceleration direction as shown on FIGS. 5 and 6, first inertial mass 26 pivots about primary rotation axis 20 along a first movement direction, driving locking device 16 such that it comes into contact with blocking device 22. Then, first elastic means 36 make locking device 16 come back to its rest position shown on FIGS. 2 to 4. However, dampening means 40 are provided such that locking device 16 comes back to its rest position only after a predetermined period of time, which for example corresponds to a nominal crash time, to ensure the locking of the door lasts long enough. By going back to its rest position, locking device 16 also drives first inertial 26 back into its rest position.

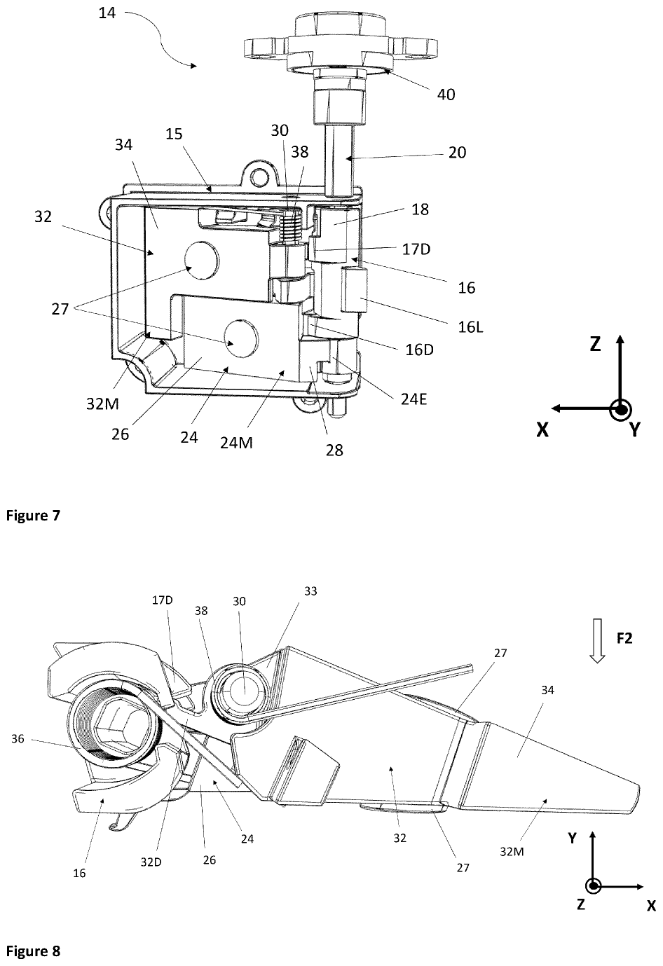

Under a force F2 along a second acceleration direction that is opposite the first acceleration as shown on FIGS. 7 and 8, second inertial mass 34 pivots about secondary rotation axis 30 along a second movement direction that is opposite the first movement direction, driving locking device 16 such that it comes into contact with blocking device 22. Then, first elastic means 36 make locking device 16 come back to its rest position shown on FIGS. 2 to 4 as well as second elastic means 38 make second inertial mass 34 come back to its rest position shown on FIGS. 2 to 4. However, dampening means 40 are provided such that locking device 16 comes back to its rest position only after a predetermined period of time, which for example corresponds to a nominal crash time, to ensure the locking of the door lasts long enough. Second elastic means 38 also make second inertial mass 34 come back to its rest position shown on FIGS. 2 to 4.

Thus one clearly understands that thanks to the presence of not one, but the two inertial masses 26, 34, and the fact that they move from a rest position to the blocking position according to two opposite directions, the inertial system 14 may act like a reversible inertial system with high sensitivity, all the while having a predictable behaviour in case of rebounds. In the case of a crash, the initial acceleration due to the impact will trigger the movement of either one of the masses 26, 34 or both, thus blocking the actuation of the door handle assembly.

Then, in the case of a rebound, even if a subsequent acceleration occurs along an opposite direction, it will not cause the unlocking of the door as it will trigger the movement of the second mass 34, thus maintaining the blocking of the actuation of the door handle assembly 10.

In addition, owing to the fact that the masses 26, 34 move from their rest position to their locking position along two different directions allows for a more compact configuration of the masses 26, 34, as they can notably be located on the same side of primary rotation axis 20 and be lodged inside a small housing 15.

### LIST OF REFERENCES

10: Vehicle door handle assembly
12: Door handle
14: Inertial system
15: Inertial system housing
16: Locking device
16D: First driven end of the locking device
16L: Locking end of the locking device
17D: Second driven end of the locking device
18: Locking body
20: Primary rotation axis
22: Blocking device
24: First pivoting part
24D: First driving end
24E: Fixed end of the first pivoting part
24M: Mass end of the first pivoting part
26: First inertial mass
27: Mass bumpers
28: First body
30: Secondary rotation axis
32: Second pivoting part
32D: Second driving end
33: Second body
34: Second inertial mass
36: First elastic means
38: Second elastic means
40: Dampening means

1-15. (canceled)

16. An inertial system for a vehicle door handle assembly comprising:
a locking device configured to prevent the actuation of the door handle upon activation;
a first inertial mass, which, when subjected to an acceleration force acting in a first acceleration direction, is configured to move along a first movement direction from a rest position allowing the opening of the door by actuation of the door handle, to a locking position activating the locking device; and
a second inertial mass, which, when subjected to an acceleration force acting in a second acceleration direction opposite the first acceleration direction, is configured to move along a second movement direction, from a rest position allowing the opening of the door by actuation of the door handle to a locking position activating the locking device, the first movement direction being opposite the second movement direction.

17. The inertial system according to claim 16, wherein the locking device comprises a locking end and at least a driven end, the locking device being movable between a locking position in which the locking end comes into contact with the door handle to prevent actuation of the door handle and a rest position into which the locking end is not in contact with the door handle, the movement between the rest and locking position and vice versa being driven by a force applied by a driving end that is linked to the first and/or second inertial mass onto the driven end.

18. The inertial system according to claim 17, wherein the movement according to which the locking device moves between the rest and the locking position is a pivoting movement.

19. The inertial system according to claim 18, further comprising a primary rotation axis and a first pivoting part pivoting about said primary rotation axis, the first inertial mass being supported by said first pivoting part,
wherein the locking device is supported by the primary rotation axis and a rotational movement of the locking device is a pivoting movement about the primary rotation axis.

20. The inertial system according to claim 19, wherein the first pivoting part comprises a first body linking a fixed end mounted on the primary rotation axis to a first mass end supporting the first inertial mass, and wherein the driven end is driven by the first body.

21. The inertial system according to claim 16, wherein the at least one driven end of the locking device comprises a first driven end and a second driven end, the movement between the rest position and the locking position and vice versa being driven by a force applied by a first driving end that is linked to the first inertial mass onto the first driven end or a force applied by a second driving end that is linked to the second inertial mass onto the second driven end.

22. The inertial system according to claim 21, wherein the second driven end is driven by the second driving end.

23. The inertial system according to claim 16, further comprising dampening means, said dampening means delaying the bringing back of the locking device from the locking position back to the rest position by a predetermined period of time.

24. The inertial system according to claim 23, where the predetermined period of time is above 0.5 seconds.

25. The inertial system according to claim 23, where the predetermined period of time is between 0.5 and 1 seconds.

26. The inertial system according to claim 17, wherein, in the locking position, the locking end comes into contact with the door handle via a blocking device.

27. The inertial system according to claim 16, further comprising a primary rotation axis and a first pivoting part pivoting about said primary rotation axis, the first inertial mass being supported by said first pivoting part.

28. The inertial system according to claim 27, wherein the first pivoting part comprises a first body linking a fixed end mounted on the primary rotation axis to a first mass end supporting the first inertial mass.

29. The inertial system according to claim 27, further comprising a secondary rotation axis and a second pivoting part pivoting about said secondary rotation axis, the second inertial mass being supported by said second pivoting part.

30. The inertial system according to claim 29, wherein the second pivoting part comprises a second driving end and a second mass end, the driving end and the second mass end being located from either side of the secondary rotation axis.

31. The inertial system according to claim 30, wherein the second driven end is driven by the second driving end.

32. The inertial system according to claim 16, further comprising first elastic means, said first elastic means being in a minimal tensile stress state when the locking device is in a rest position, and configured to apply a force or torque on the locking device, to bring said locking device from the locking position back in the rest position.

33. The inertial system according to claim 16, further comprising second elastic means, said second elastic means being in a minimal tensile stress state when the second inertial mass is in the rest position, and configured to apply a force or torque on the second inertial mass, to bring said second inertial mass from the locking position back in the rest position.

34. The inertial system according to claim 16, wherein at least one of the first and second inertial masses comprises a socket in which a bumper can be inserted.

35. The inertial system according to claim 34, wherein said bumper is made out of rubber and injected in the socket.
